(19) United States
(12) Patent Application Publication
(10) Pub. No.: US 2015/0269599 A1
(43) Pub. Date: Sep. 24, 2015

(54) SYSTEM FOR SELLING PRODUCTS BY PROVIDING RAFFLE TYPE CASH REWARDS BASED ON QR CODE AND SERVICE METHOD FOR SELLING PRODUCTS USING SAME

(71) Applicant: Chang Keun Lee, Gyeonggi-do (KR)

(72) Inventor: Chang Keun Lee, Gyeonggi-do (KR)

(21) Appl. No.: 14/116,865

(22) PCT Filed: Apr. 23, 2012
(86) PCT No.: PCT/KR2012/003122

§ 371 Date: Jun. 8, 2015

(30) Foreign Application Priority Data
May 11, 2011 (KR) 10-2011-0043824

(51) Int. Cl. G06Q 30/02

(52) U.S. Cl. CPC G06Q 30/0212

(57) ABSTRACT

This invention is for a lottery-typed product sales system for cash rewarding based on a QR code and a lottery-typed product sales service method using the system, and the purpose of the technical realization is offering a lottery-typed product sales system for cash rewarding based on a QR code and a lottery-typed product sales service method using the system in order to make users (customers)'s consumption activities become rather a new means of financial technology that is able to create a large profit; promote a purchasing rate, for product sellers like a store, a company and so on, by attracting target customers much efficiently and systematically; and maximize sales.

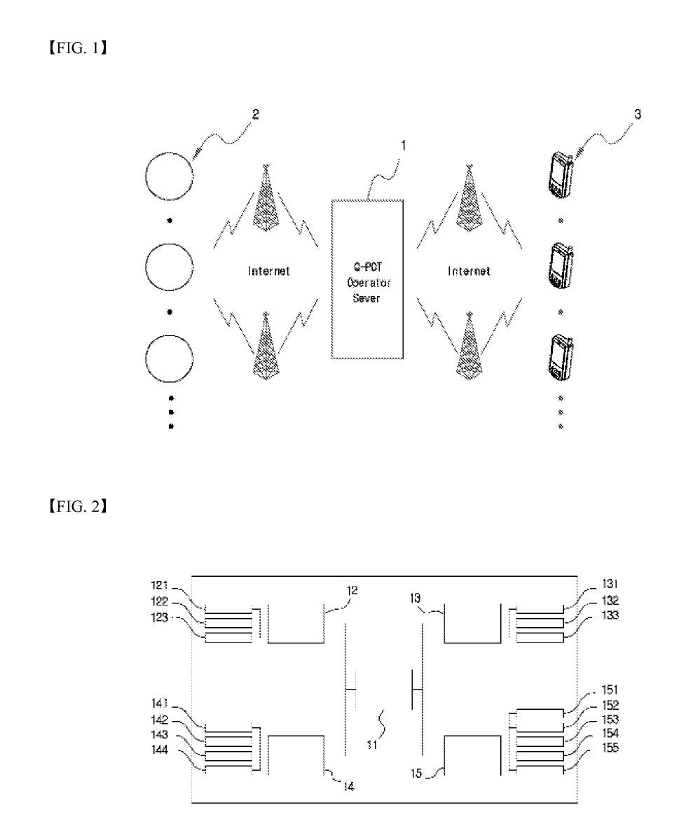

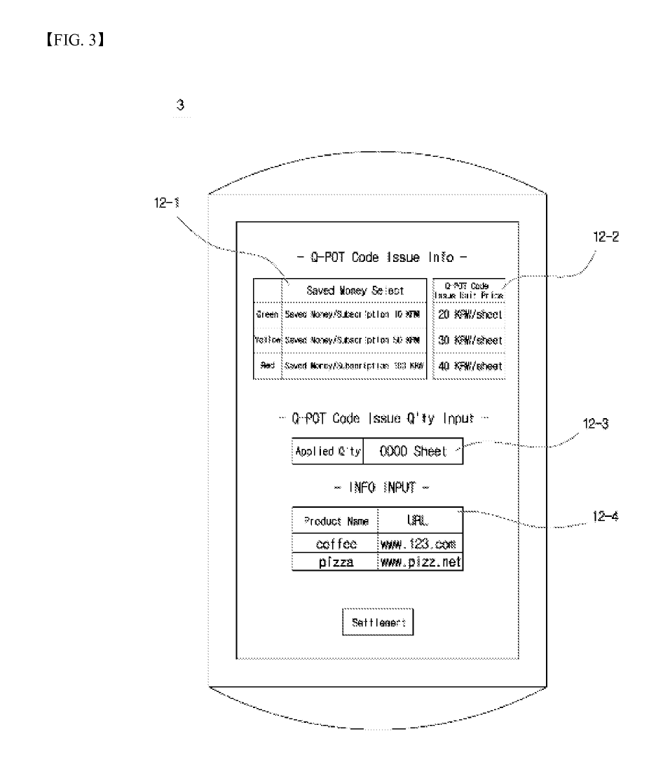

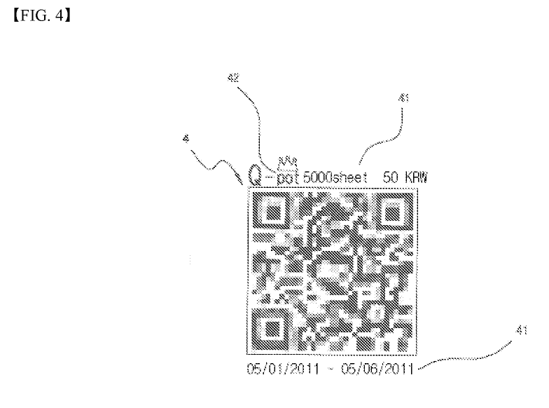

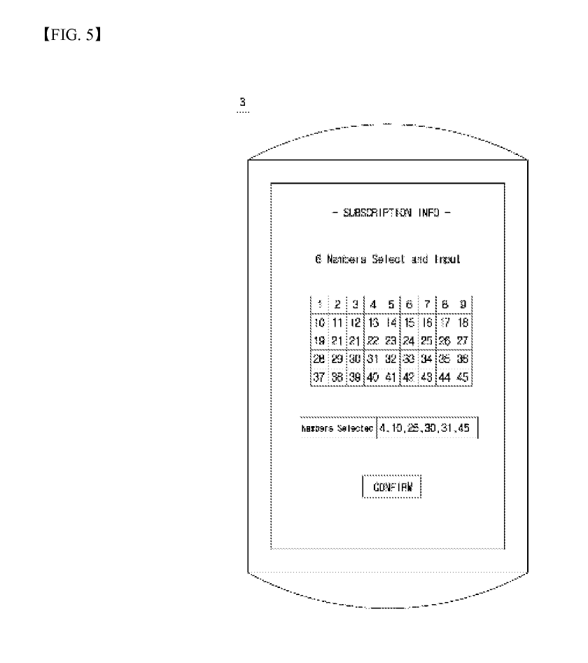

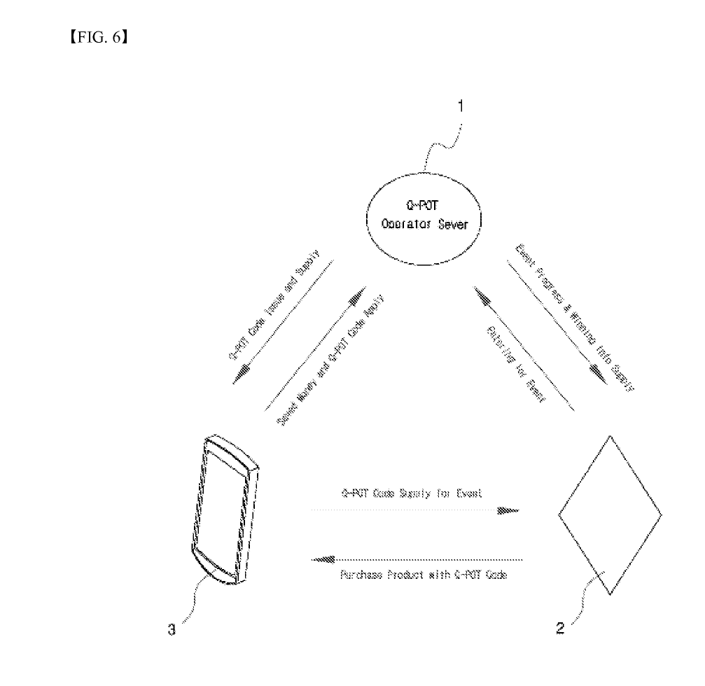

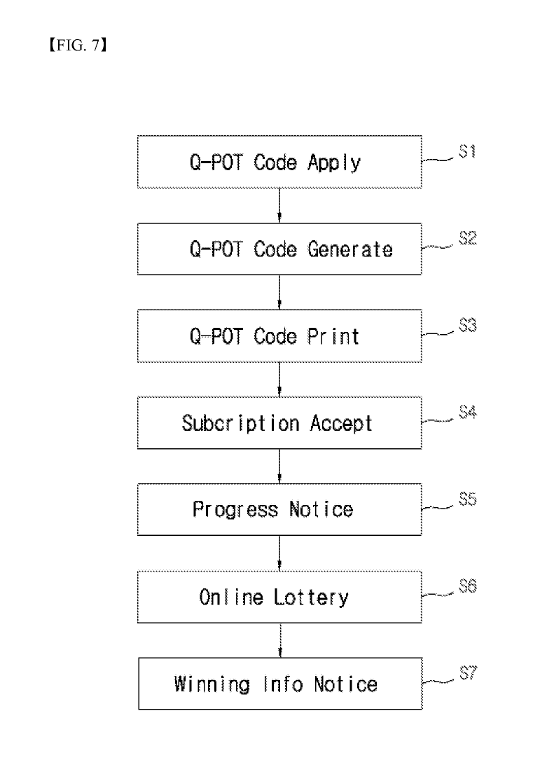

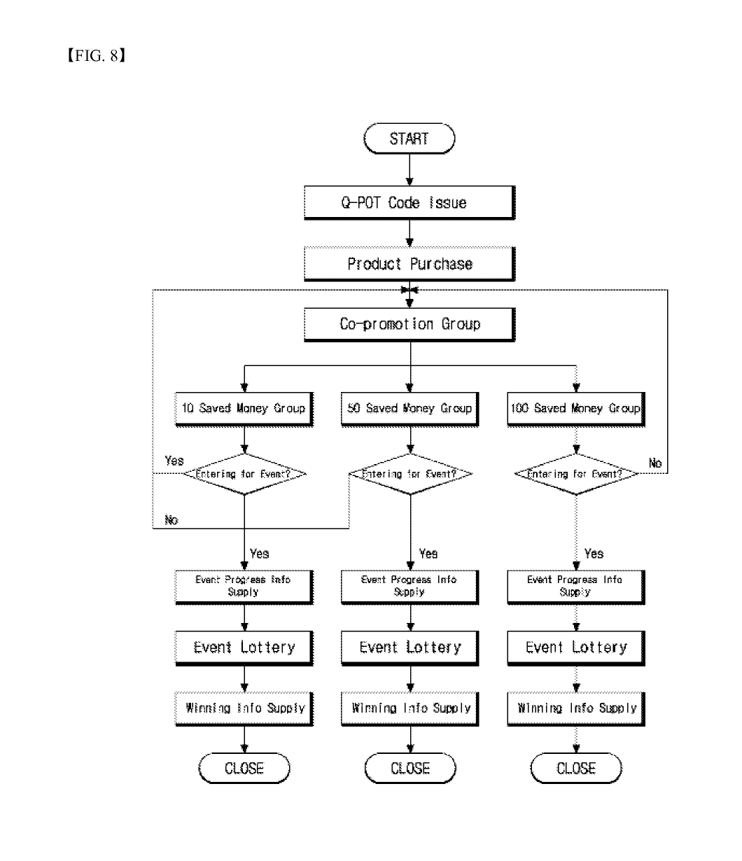

Accordingly, the concrete means to accomplish above purpose are to link this system with Q-POT operator server online, to build an individual sales server in order to apply the issuance of the Q-POT code to be attached to sales products, and to be equipped with a user smart terminal in order to enter for an event by scanning the Q-POT code attached.

In addition to above, the purpose is accomplished by carrying out the seven (7) steps of (S1) Q-POT Code Apply, (S2) Q-POT Code Generate, (S3) Q-POT Code Print, (S4) Subscription Accept, (S5) Progress Notice, (S6) Online Lottery and (S7) Winning Info Notice using a series of system aforementioned.

### TECHNICAL FIELD

This invention is for Product Sales system using QR cord (Quick response code) and the service method. In more detail, it additionally enters and supplies a user with exclusive identification information in relation to subscription to QR code which has been widely used as a commercial marketing method in various fields or a public relation (PR) means. If a user purchasing all kinds of goods and services based on such system scans above QR code with a QR code awareness program in a smart terminal, this system offers an opportunity to enter for an event by lottery to a user so that the user may challenge to a prize money accumulated from servers of many individual sellers who participated in joint promotion before and/or after linking to URL (Uniform resource locator) interlocking with the QR code. If the user wins as a result of a lottery, this system helps, by letting the user's smart terminal acquire the cumulative a prize money mentioned above, customers in arousing their interest to buy because of the high prize money and helps many individual goods and service sellers who participated in joint promotion using a QR code raise a sales rate; and it, to users-customers, not only meets their desires by purchasing goods and service but also lead them to expect additional earnings by entering for an event.

### Background Art

A QR code (QR: Quick Response Code) means a type of matrix bar code showing information in a grid pattern and a two-dimensional (2D) bar code, which the data capacity has rapidly increased as much as that the recordable amount of data is 7,089 letters as compared with a one-dimensional (1D) bar code that a recordable amount of data is just 20 letters. It is possible to offer additionally data: a video, a picture and a music, based on such a large data capacity as well as to access a certain web site, move to it and see summarized production information. Enterprises or sellers in various fields of industries are, by exposing many and unspecified potential consumers (customers) to such QR code, using it as one of diverse ways to them like motivating them to link company information, all sorts of promotional videos or sites as well as additional product and service information

Moreover, a QR code has been rapidly come into the spotlight as a new promotional means or marketing channel in an advertising industry because a smart phone has been lately come into wide use and users who want to access further more information by downloading an exclusive application to scan a QR code to a smart terminal are increasing.

Particularly, utilization of a QR code, as aforementioned, has been risen by the wide diffusion of a smart phone. If a user(customer) downloads an exclusive application for scanning a QR code to its own smart phone and then puts the smart phone camera equipped with the exclusive application to a QR code like taking a picture, the user is able to acquire various information recorded into the QR shown on the screen of the smart phone or URL linked with the QR code.

If a user, for instance, scans the QR code attached to a product such as vegetables, fruits, fishes, etc., further information like production, manufacturing, distribution history and so on can be acquired via a smart phone. In addition, if a user scans a QR code printed on promotional materials: a brochure, a flyer, a leaflet, etc. of a department store, it is linked with the web site of the department store according to URL information recorded in the QR code and it becomes possible to access detail information such as a product image or video, items on sale by brands, all sorts of giveaways, hot events, etc. which could not be shown on the paper promotional materials; else, if a user scans it attached to next to an exhibit in a cultural event like an art exhibition, detail information about the painter and the art work is shown on the screen of user's smart phone.

That is, a QR code is, for whole sellers of groceries, distribution enterprises operating a department store or sponsors, hosts, or promoters of exhibitions, becoming a efficient channel to deliver information and data that they want to let the public know and is carrying out a role for users as a channel to acquire further information and data about their areas of concern. Accordingly, many vendors, distributors or sellers have recently made an effort to make a QR code a medium to prospect for potential consumers.

All kinds of commercial marketing and promotional ways using above-mentioned QR code become a very useful channel for enterprise groups or sellers that want to offer various information to the many unspecified and a the people who want to get further information or data about their areas of concern, but such a QR code has a limit that massive information and data in a QR code cannot be delivered properly unless users(customers) actively take a positive action—an active action to acquire such information and data with interest—that they spontaneously scan a QR code distributed on/off line and acquire the information and data.

Besides, sellers or information providers who want to get promotional and marketing effect by a means of a QR code are remarkably increasing and frequency of QR codes exposed to the public is getting higher. So, QR codes that users meet everywhere in living are useful channels to acquire information required for consumption activities for them, but on the other hand, users who already are living in the flood of advertisement on/off line are treating them as one of a number of advertisements.

The existing QR codes, being used as aforementioned, are just simple means of public relations randomly distributed in order to diffuse commercial information and data about goods, service, company information, etc. to the public, and an organized analysis system or way for that what information or advertisement delivered by a QR code is exposed to whom and how much has not been set up yet. Especially, there is no any specific plan for how to invite expectation of users(customers) who meet much more information via a QR code and how to connect such expectation to their actual purchasing behavior.

As part of efforts to connect users' expectation to their actual purchasing activity, thus, several plans—giving a certain discount benefit to users(customers) accessing a certain URL via a QR code when they purchase by offering a mobile coupon or offering a ranking giveaway to them by lot by offering a coupon to enter for an event—have been recently suggested.

Notwithstanding such offering a mobile coupon or a coupon to enter for an event using a QR code is executed for the purpose of induction of users' revisit or repeated purchase, however, it is actually skeptical of the effect to actively arouse users' expectation or to strongly inspire their purchase intention.

For example, a user, in order to get a certain discount or a coupon when purchasing a goods, needs to search for the QR code distributed on/off line by the seller, operate an application to scan a QR code on a smart phone, scan the QR code desired, acquire a mobile coupon on the URL page liked, show the mobile coupon downloaded to the store and make a payment with the coupon. Some users may sufficiently endure such a series of process for reasonable consumption, but most of users become realize that the effective value obtained from such a complicated procedure is smaller as compared their effort. For that reason, offering a mobile coupon using a QR code is unsuccessful for leading big response from many users unlike its initial intention.

Some sellers or service providers are carrying out an event, which suggests a giveaway to a user accessing a product or service via a QR code and offers a coupon to enter for the event. That is, if a user accesses the URL set by the promoter of a giveaway event by scanning the QR code distributed on/off line by a specific seller or service provider, an opportunity to enter for the event is given to the user via a smart terminal. It reserves an outstanding accessibility in a promotional event that everybody can enter for the event regardless of whether or not a user purchases goods and for users, it shows a very useful effect in the viewpoint that a user may have an expectation to get a giveaway just by scanning a QR code.

It is only failing to effectively arouse users' expectation because a giveaway event linked with above QR code, etc. is sporadically carried out according to the judgment and needs of individual sellers or service providers.

Because each seller or service provider: a pizzeria, a snack bar, a quick service courier, a supermarket, a vegetable store and so on, shall bear several costs and expenses required to promote an event, distribute a QR code on/off line, build a computer infrastructure to process a data entered to a smart terminal, to draw for winners and to deliver a giveaway to a winner as well as a basic cost required to prepare for the giveaways when it respectively carries out a giveaway event. That is, there is inefficiency of overlapping investment that every seller, provider or company carrying out a giveaway event shall bear without exception.

Naturally, such costs and expenses may be a small thing to large enterprises or famous brand companies. But such incidental costs and expenses to an event, except for the costs to procure giveaways to be offered to subscribers, are economically and technically demanding to a small store or the minor self-employed like a pizzeria or a snack bar and a small-scale businessman/enterprise like a quick service courier or a laundry. Concerning such actualities, a problem that there are many goods and service providers that cannot participate in such a promotional event in spite of several desirable effects of a giveaway promotion using a QR code.

In addition, there is a big difference on the quality of giveaway according to capital strength of an event promoter or a product brand because individual companies sporadically carries out an event.

A large enterprise may offer costly home appliances, tickets to travel or high-priced gift cards, etc. as a giveaway, but a small-sized company cannot help offering fixed service vouchers or low-priced goods. In spite of a capacity to induce users' participation, that is why the negative effect that the logic of capitalism is reflected in full is still exist.

Users cannot help but feel inconvenience because they, in spite of winning the event, consider that the benefit in return for most of giveaway promotions is small and can expect only a small additional revenue like a laptop computer, a television, a refrigerator, a ticket to travel, etc. under a low winning probability.

Under the situation that a giveaway event using a QR code is sporadically held by an individual subject(individual sellers and service providers) without any associativity or integration, accordingly, ineffectiveness by the overlapping investment to incidental costs and expenses is continuous to be repeated. Also, it is difficult to properly secure users' expectation under the situation that most of events consist of low-priced giveaways. Its the most negative point is that it is difficult to smoothly accomplish the initial purpose of an event promoter—the resale or repeated purchase of goods or services.

### DETAILED DESCRIPTION OF THE INVENTION

### Technical Solution

Accordingly, this invention, based on a QR code, is designed for offering a new Product Sales system and the service method using the system that has never been approached in the past.

This invention is an event agency service under co-promotion (called as “Q-POT Service) based on a QR code, make a co-promotion agency contract with Q-POT Operator Server by linking servers of unspecified and many individual sellers who want to raise a sales rate of goods and service with Q-POT Operator Server, then offers a QR code used for a co-promotion event (hereinafter, referred to as “Q-POT code”)—a new mode of co-promotion QR code including identification information and a mark for an event to the servers of individual sellers who has enter into an agency contract after fixing a cost and quantity required to handle one (1) entry for an event. The purpose of this invention, by doing this, is to induce a potential consumer to purchase the goods with a Q-POT code by letting a potential consumer recognize “You get a chance for a large giveaway(prize money) on this goods by co-promotion” when seeing the above Q-POT code attached to goods on sale; and to offer a lottery-typed Goods Selling System for cash rewarding and Goods selling service method using the system based on a QR code so that a user can have an opportunity to enter for a lottery-typed co-promotional event by scanning a Q-POT code of the goods with its smart terminal The other purpose of this system, by generating a large prize money by saving the agreed costs for handling an event as an integrated prize money of co-promotion, by suggesting it to a user, provided that a user purchases a goods attached with a Q-POT code—the goods on servers of many individual sellers(of company A, B, C . . . Z, etc.) integrated into a co-promotion system and its smart terminal enters for an event by scanning the attached Q-POT code, is to offer the much higher rewards than the existing individual and sporadic events, to have a user an opportunity to get the cumulative prize money integrated as above by purchasing any product on the server of the individual seller, which participated in co-promotion, and to offer a lottery-typed Product Sales system for cash rewarding based on QR code and Product Sales service method using the system in order to induce users' purchasing activity more aggressively.

Another purpose of this invention, by enlarging the scale of the prize money deducted or accumulated from the servers of individual sellers in proportion to the number of smart terminals entering for a co-promotion event with scanning of the Q-POT code attached to a goods and by generating “a virtuous cycle” increasing the sales of goods and service on the servers of individual sellers participating in a co-promotion event in proportion to the number of users entering for the cumulative prize money with arousal of users' expectation based on the cumulative prize money, is to make the individual sellers enjoy PR effectiveness that could not expect under the existing high expenditure and low efficient events and simultaneously offer the effect to actively increase a rate of sales to them; offer a user—the event participant—a chance to secure the cumulative prize money integrated from several servers of sellers by taking part in the co-promotion event via a Q-POT code as well as the usefulness getting from consumption of goods and service; offer an event winner an effect to secure a high prize money, not a fixed laptop computer or a laundry; offer a Q-POT operator a lottery-typed Product Sales system for cash rewarding based on QR code and Product Sales service method using the system generating an added value like an agent commission by issuing and distributing a Q-POT code to sellers.

### Means for Solving Problems

Accordingly, the concrete means of a lottery-typed Product Sales system for cash rewarding based on QR code and Product Sales service method using the system in order to accomplish above purposes are to be equipped with Q-POT Operator Server, Individual Seller Server which is in charge of application and issuance of a Q-POT code to be linked with Q-POT Operator Server and to be attached to a goods and User Smart Terminal to scan a Q-POT code attached to goods to purchase; and to build, using a series of system, all the procedures such as a step of Q-POT Code Apply, Q-POT Code Generate, Q-POT Code Print, Subscription Accept, Progress Notice, Online Lottery, Winning Info Notice and so on.

### Effects of the Invention

By attaching “Q-POT code” which an identification information and a mark to enter for an event are specially added to the existing QR code to the goods that an individual seller wants to increase a rate of sales; and by paying a cumulative and large prize money when winning to a user in cash after giving the smart terminal of a user a chance to acquire a prize money accumulated by entering for an event, ┌A lottery-typed Product Sales system for cash rewarding based on QR code and Product Sales service method using the system┐ under this invention offers a user(customer) a new means of a financial technology that its purchasing activity for self-satisfaction returns as a large added value; reduces, for product sellers like a store, a company, etc., the financial burden for a sporadical event, greatly improves reactions of users by enlarging the scale of a prize money to offer, and promotes sales of goods and service; offer Q-POT operators a very useful expected effect creating a new added value by acting all kinds of processes regarding the management of Q-POT codes and application for events required for co-promotion as an agent.

### BRIEF DESCRIPTION OF DRAWINGS

[Drawing 1]: The schematic block diagram of a lottery-typed Product Sales system for cash rewarding based a QR code under this invention.

[Drawing 2]: The schematic block diagram of Q-POT Operator Server applied to this invention.

[Drawing 3]: The block diagram of a web screen to apply the issuance of a Q-POT code applied to this invention.

[Drawing 4]: The whole conceptual diagram of a lottery-typed Product Sales service method for cash rewarding based a QR code under this invention.

[Drawing 5]: The state diagram for generation of a Q-POT code applied to this invention.

[Drawing 6]: The schematic diagram for display information of an input mode for a subscription number applied to this invention.

[Drawing 7]: The flowchart I.

[Drawing 8]: The flowchart II.

### DETAILS TO EXECUTE THE INVENTION

The configuration of a desirable embodiment of a lottery-typed Product Sales system for cash rewarding based on a QR code and the Product Sales service method using the system under this intention will be explained in detail by the attached drawings. According to the attached drawings, firstly, this invention consists of (1) Q-POT Operator Server, (2) Individual seller server and (3) User smart terminal. First, in above system configuration, (1) Q-POT Operator Server is a qualification to enter for a cash reward event, which is, as displayed in [Drawing 4], a configuration of a main web site of this invention to offer an opportunity to get a prize money to (3) User Smart Terminal by issuing (4) Q-POT code and offer service to raise a rate of sales to (2) Individual Seller Server. Such (1) Q-POT Operator Server includes Auto Info Process Unit as displayed in [Drawing 2], and additionally (12) Co-promotion Code Issue Apply Unit, (13) Code Issue Control Unit, (14) Subscription Accept Process Unit and (15) Operational Status Manage Unit shall be equipped.

Above (11) Auto Info Process Unit in (1) Q-POT Operator Server is a common online medium designed for classifying (2) Individual Seller Server and (3) User Smart Terminal by a service type and connecting (2) Individual Seller Server and (3) User Smart Terminal with (1) Q-POT Operator Server online in real time. So, (11) Auto Info Process Unit configures another server with same function and configuration as above and offers a membership application service, a text and message transmission service, a manual operating service by producing a web browser and all kinds of data transmission services like voice, a video, a static image and so on.

Above (12) Co-promotion Code Issue Apply Unit in (1) Q-POT Operator Server is (2) Individual Seller Server who wants to increase a rate of sales—for example, (4) Q-POT Code to be attached to goods and service, etc. handled by many and unspecified individual sellers operating a company, a store, all sorts of business branches, etc. from (2) their servers—it is, as displayed in [Drawing 4], a means to optionally apply issuance of (4) Q-POT Code generated as a new title by adding new technical elements (identification information for event subscription and an identification mark, etc.) based on the existing QR code so that it is suitable for this invention. Such (12) Co-promotion Code Issue Apply Unit shall be equipped with a web program consisting of (121) Code Issue Quantity Set Mode, (122) Saved Money Select Mode and (123) Seller Info Database as displayed in [Drawing].

Above (13) Code Issue Control Unit in (1) Q-POT Operator Server is a means to generate and issue (4) Q-POT code applied by (2) Individual Seller Server according to the quantity applied, shall be equipped with a web program consisting of (131) Q-POT Code Generate Mode and (132) Device Control Mode as displayed in [Drawing 2], and shall be built by connecting (133) Q-POT Code Issuer with an interface as a sort of an output means operated and controlled by (132) Device Control Mode.

Above (14) Subscription Accept Process Unit in (1) Q-POT Operator Server is a means to induce and guide so that (3) User Smart Terminal purchasing and acquiring the goods with a Q-POT code enters for a lottery-typed giveaway event by scanning (4) the Q-POT code attached to the goods purchased. (14) it shall be equipped with a web program consisting of (141) Subscription Info Supply Mode, (142) Subscription Number Input Mode, (143) Set Advertisement Pop-up Mode and (144) Subscriber Info Database as displayed in [Drawing 2].

Above (15) Operational Status Manage Unit in (1) Q-POT Operator Server is a means to offer a series of event progressing data to (3) User Smart Terminal in real time if (3) the smart terminal enters for a lottery event by scanning a Q-POT code, and it shall be equipped with a web program consisting of (151) Cumulative Prize Money Output Mode, (152) Subscription Rate Analysis Mode, (153) Progress Data Pop-up Mode, (154) Lottery Manage Mode and (155) Winning Settlement Mode as displayed in [Drawing 2].

The second, above (2) Individual Seller Server in system configuration of this invention means a web site of the seller who wants to increase a rate of sales for goods and service handled—for example, configuration of unspecified and many individual web sites operating a company, a store, all sort of business branches, etc., and (2) it is subject to participate as a member of co-promotion without any limitation of a type of business and goods handled and shall be equipped with a common information data transmission unit(omitted the drawing).

Finally, above (3) User Smart Terminal in system configuration of this invention means many and unspecified users who want to have an opportunity to acquire a prize money by entering for a lottery event using (4) Q-POT code, for example, a common smart phone which is able to connect to internet without any space and time limit. (3) It shall be equipped with an exclusive scan application of a Q-POT code supplied by (1) Q-POT Operator Server.

Accordingly, this invention consisting of a series of system mentioned above realizes a lottery-typed Product Sales service method for cash rewarding based on a differentiated QR code using the system built, and the configuration of a desirable embodiment will be explained in detail by the attached drawings.

[Drawing 4] is the whole conceptual diagram for a lottery-typed Product Sales service method for cash rewarding based on a QR code under this invention, [Drawing 5] is the state diagram for generation of a Q-POT code applied to this invention, [Drawing 6] is the schematic diagram for display information of an input mode for a subscription number applied to this invention, [Drawing 7] is the flowchart I of a lottery-typed Product Sales service method for cash rewarding based on a QR code under this invention, and [Drawing 8] is the flowchart II of a lottery-typed Product Sales service method for cash rewarding based on a QR code under this invention. Thus, a series of the methodical configuration consists of total seven steps of (S1) Q-POT Code Apply, (S2) Q-POT Code Generate, (S3) Q-POT Code Print, (S4) Subscription Accept, (S5) Progress Notice, (S6) Online Lottery and (S7) Winning Info Notice.

Whereas, a step of (S1) Q-POT Code Apply consists of total three (3) processes: linking (2) the servers of many and unspecified individual sellers who want to raise a rate of sales for goods handled and pay service to (1) Q-POT Operator Server via (11) Auto Info Process Unit; inputting and applying the issuance quantity of a Q-POT code, with (2) Individual Seller Server linked, that a seller wants to attach to its goods (a server of an individual producer) via (121) Code Issue Quantity Set Mode installed in (12) Co-promotion Code Issue Apply Unit; and much more selecting and inputting a saved prize money desired per Q-POT code applied to issue via (122) Saved Money Select Mode.

When (2) Individual Seller Server applies to issue a Q-POT code, (121) Code Issue Quantity Set Mode and (122) Saved Money Select Mode installed in (12) Co-promotion Code Issue Apply Unit offer (12-1) Saved Money Select Screen per Unit Price classified and set by a color list, (12-2) Purchase Commission Info Screen per Q-POT code, (12-3) Code Issue Quantity Input Screen and (12-4) Product Info Screen sold as display information via the web screen of (1) Q-POT Operator Server as displayed in [Drawing 3]. So, (2) it sets a prize money desired per Q-POT code and a quantity to purchase (4) Q-POT code via a series of windows displayed and inputs additional information to be linked with (4) Q-POT code purchased.

For example, if (12-1) Saved Money Select Screen per Unit Price supplied by the information displayed on a web screen of (a) Q-POT Operator Server, as displayed in [Drawing 3], offers information to select a unit price by being classified as three (3) colors: Green(a saved money per subscription : 20 KRW), Yellow(a saved money per subscription: 50 KRW) and Red(a saved money per subscription: 100 KRW) and (12-2) Purchase Commission Info Screen per Q-POT Code offers optional purchasing information such as 20, 30, 40 KRW per issuance of one (1) Q-POT code, (2) Individual Seller Server confirms the issuance cost of the Q-POT code by totalling up the saved money per alternative Q-POT code and the fee through the information supplied in (12-1) Saved Money Select Screen per Unit Price and (12-2) Purchase Commission Info Screen per Q-POT Code.

The concrete example for above procedure is as followings. If the target goods to attach a Q-POT code for raising a rate of sales is an instant coffee mix and the sales profit per an instant coffee mix is 100 KRW, (2) Individual Seller Server considers an additional Q-POT purchasing cost of, e.g. 20 KRW when applying issuance of one (1) Q-POT within a scope which does not exceed the profit of 100 KRW; sets a saved money desired per Q-POT code by clicking the yellow screen equivalent to a saved money of 50 KRW per subscription; figures out the expected costs required to participate in this system with above cost information: for example, 20 KRW as purchasing cost one (1) Q-POT code+50 KRW as a saved money per subscription=70 KRW as a handling charge per subscription; applies issuance of Q-POT codes desired by making a payment after inputting a quantity required (for example, 5,000 sheets) in figures on (12-3) Code Issue Quantity Input Screen; simultaneously with the application of the issuance, inputs product information of an instant coffee mix and basic information for (2) Individual Seller Server: a company name, a corporate registration number, URL address, e-mail and so on.

The application of issuance of a Q-POT code, at this time, is not limited to a certain (2) Individual Seller Server but opened to (2) servers of many individual sellers selecting same unit price information as a type of co-promotion, provided that the saved money per Q-POT code set by an individual seller is same as the one set by other individual sellers: for example, Green(a saved money per subscription: 20 KRW), Yellow(a saved money per subscription: 50 KRW) and Red(a saved money per subscription: 100 KRW). In other words, this system provides an after-mentioned series of lottery events and a prize money payment service according to a group category is integrated by a group with the same saved money per subscription as displayed in [Drawing 8].

If (2) Individual Seller Server applies to issue a Q-POT code via (S1) Q-POT Code Apply, (1) Q-POT Operator Server, in the step of (S2) Q-POT Code Generate, generates URL address of (2) Individual Seller Server, other advertisement data and (4) Q-POT code including subscription limit code information via (131) Q-POT Code Generate Mode installed in (13) Code Issue Control Unit according to the issuance data applied by (2) Individual Seller Server; and shall include (41) Subscription Identify Info and (42) Subscription Identify Mark as displayed in [Drawing 4].

Aforementioned (4) Q-POT code is, with the same type of matrix as a common QR code, a common bar code that is able to record and save diverse information and data including a letter, a figure, an image and other 3D information, etc. This invention partially applies only additional components with such a common QR code as it is. If (2) Individual Seller Server applying issuance of a Q-POT code applies the purchase and issuance of a Q-POT code with a set quantity of 5,000 sheets as a server of the manufacturer and seller of an instant coffee mix, (1) Q-POT Operator Server generates a Q-POT code with the same type as a common QR code via (131) Q-POT Code Generate Mode; gives URL address information to induce linking to the web site of (2) Individual Seller Server to (4) Q-POT Code generated, basic information like another advertisement data information additionally manufactured for promotion of (2) Individual Seller Server and subscription limit code information which is an exclusive identification number to prevent overlap for No. 1˜No. 5,000 of the issuance number of Q-POT code; records and inputs limited set information that is able to enter for an event one (1) time per Q-POT code issued; generates, without any violation on a pattern of (4) Q-POT Code generated, (42) Subscription Identify Mark representing (4) Q-POT Code given an opportunity to enter for an event, event information like a event subscription period—e.g. “May 1, 2011-May 6, 2011” and (41) Subscription Identify Info shown as “total quantity of (4) Q-POT Code issued (5,000)×a saved money per subscription (50 KRW)” as displayed in [Drawing 4].

In a step of (S3) Q-POT Code Print, a Q-POT code is printed and supplied within the scope of the set quantity of (4) Q-POT Code generated in the step of (S2) Q-POT Code Generate. In case of (1) Q-POT Operator Server, (S3) it sets and selects a printing paper and the number of sheets to print by the set control of (132) Device Control Mode installed in (13) Code Issue Control Unit and prints, (4) the Q-POT codes applied by (2) Individual Seller Server in a form of printout by operating (133) Q-POT Code Issuer under the interface control of (132) Device Control Mode as displayed in [Drawing 4]. The (4) Q-POT codes printed as above are offered to (2) Individual Seller Server who applied the issuance in a form of printout, and (2) the server of an individual seller receiving the printout of Q-POT codes cuts (4) it as one (1) sheet and attaches each Q-POT code to its products.

In addition, the (4) Q-POT codes printed are optionally printable on a sticky paper so that (4) they are stably attached on the exterior of products consisting of a glass bottle or a can like Coke, Sprite, Soju, etc. In case of products using packing materials of packing film like chips, Ramens(noodle soup), breads, etc., also, the (4) Q-POT codes cut as one (1) sheet are stably included and attached inside of the packing material by coating the (4) Q-POT codes on a vinyl film paper.

Such a series of process cutting and attaching (4) them to products is just a physical activity. So, the process attaching (4) them is excluded from the object of right under this invention.

In a step of (S4) Subscription Accept, many and unspecified users optionally purchases the products with (4) Q-POT Code and then links its smart terminal to (1) Q-POT Operator Server by scanning (4) it with its smart terminal

The (1) Q-POT Operator Server, for the (3) smart terminal linked to Q-POT Operator Server via (141) Subscription Info Supply Mode installed in (14) Subscription Accept Process Unit as displayed in [Drawing 6], offers subscription information displayed on the screen—for example, shown as a message of “For auto subscription, select six (6) numbers with a number keys (1-45) and click [Confirm]”, subscription period information shown as a message of “May 1, 2011—at midnight of May 6, 2011” and a lottery information as shown a message of “Lottery on May 7, 2011 4PM” as well as (41) Subscription Identify Info. p So, (3) User Smart Terminal, according to the several subscription information supplied as above, enters for an event by optionally selecting and inputting 6 numbers to be expected as a winning number using number keys (1-45) with the same method as common Lotto Lottery via (142) Subscription Number Input Mode installed in (14) Subscription Accept Process Unit, and the subscription information for the (3) smart terminal entering for an event is saved in (144) Subscriber Info Database installed in (14) Subscription Accept Process Unit by (1) Q-POT Operator Server.

When the (3) smart terminal inputs and applies 6 expected winning numbers via (142) Subscription Number Input Mode, the (1) Q-POT Operator Server sets a waiting time of approximately 2-5 sec. during that the subscription information of (3) the smart terminal is transmitted and accepted and then offers another product information with (4) Q-POT Code: a notice or promotional data for new product release of an individual seller that is able to enter for a lottery event or additional advertisement like a letter, an image, a video, etc.—by displaying them on the (3) smart terminal via (143) Set Advertisement Pop-up Mode installed in (14) Subscription Accept Process Unit for such a waiting time. Moreover, (1) Q-POT Operator Server gives ID and Password to (3) the smart terminals entering for an event by scanning (4) Q-POT Code and then gives them qualification for membership that is able to enter for an event after acquiring basic personal information(names, ages, sex, e-mail, a serial number of the terminal, etc.) from (3) them. This system is not beyond the bounds of this invention.

In a step of (S5) Progress Notice, if (3) User Smart Terminal enters for an event via the step of (S4) Subscription Accept aforementioned under this invention, (1) Q-POT Operator Server, for the (3) smart terminals entering for an event, displays a current subscription rate and cumulative prize money calculated by (152) Subscription Rate Analysis Mode and (151) Cumulative Prize Money Output Mode installed in (15) Operational Status Manage Unit on the (3) smart terminals via (153) Progress Data Pop-up Mode in real time.

If (3) User Smart Terminal enters for an event by scanning (4) a Q-POT code after purchasing an instant coffee mix with (4) it and consequently a saved money per (4) Q-POT code entered is 50 KRW, for example, (1) Q-POT Operator Server offers the quantity information for the whole (4) Q-POT codes of the sellers' group(servers of individual sellers) participating in co-promotion that a saved money per (4) Q-POT code is equally set and issued by (15) Operational Status Manage Unit.

In succession, if total quantity of (4) Q-POT codes set and issued such as Company A (Individual Seller Server)'s the number of Q-POT codes issued is 20,000 sheets for raising a rate of sales of an instant coffee mix, Company B's the number of Q-POT codes issued is 15,000 sheets for raising a rate of sales of pizza and Company C's the number of Q-POT codes issued is 50,000 sheets for raising a rate of sales of beer under the same saved money is 100,000 sheets, (1) Q-POT Operator Server offers a series of subscription progress information shown as a message or a graph of “total 100,000 Q-POT codes issued”, “current 63,000 subscribed” and “current 63% subscribed” via (152) Subscription Rate Analysis Mode and additionally offers total current saved money calculated as “50 KRW of a saved money per Q-POT code×63,000 of current subscription=3,150,000 KRW” via (151) Cumulative Prize Money Output Mode.

A step of (S6) Online Lottery is to determine a winner for the (3) user smart terminals entering for an event by scanning a Q-POT code. In (S6) this step, (1) Q-POT Operator Server extracts a winning number according to a lottery date and time set by (154) Lottery Manage Mode installed in (15) Operational Status Manage Unit and lets users know whether it wins or not by transmitting the winning number extracted to (3) their smart terminals entering for an event.

The winning number extracted by (154) Lottery Manage Mode under this invention uses, as it is, the real-time winning number of a Lotto Lottery currently carried out offline for the purpose of credibility and fairness. This invention may confirm a winner by producing an exclusive internet lottery broadcasting or designing an auto lottery winning number extraction system, and such methods to extract a winning number is not beyond the bounds of this invention.

In addition to above, the regulations of ranking lottery carried out in the step of (S6) Online Lottery is same as a common Lotto Lottery. That is, the user guessing correctly all 6 numbers takes first place, the user guessing 5 numbers takes second place and the user guessing 4 numbers takes third place.

Finally, a step of (S7) Winning Info Notice is to offer real-time winning information to the (3) user smart terminal won by a step of (S6) Online Lottery. (S7) this step realizes a lottery-typed Product Sales service method for cash rewarding based on a QR code under this invention by extracting the information of the winning (3) user smart terminal like the call number information and subscription information from (144) Subscriber Info Database, by calculating the cumulative prize money, how to receive the prize money, the payment period, the tax amount to be deducted and the service charge to be deducted via (155) Winning Settlement Mode installed in (15) Operational Status Manage Unit and by transmitting such settlement information to the winning (3) user smart terminal.

The prize money will be paid to the winning (3) user smart terminal in cumulative saving points like online cash points as well as cash payment like online transfer, on-the-spot direct payment, etc., and such how to pay a prize money is not beyond the bounds of this invention, too.

Meanwhile, this invention may be applicable for another embodiment. Another embodiment to be applied to this invention is followings. The (4) Q-POT code generated in the step of (S1) Q-POT Code Apply is attached to goods of (2) Individual Seller Server sold in an online shopping mall, etc. as an online transmission data. Next, (3) User Smart Terminal decides to purchase the goods and completes payment. (2) Individual Seller Server displays and transmits the (4) Q-POT code attached to the goods, and (3) User Smart Terminal may get an opportunity to enter for an event and lottery service by scanning (4) it. Such additional embodiment is not beyond the bounds of this invention.

1. ┌Lottery-Typed Product Sales System for Cash rewarding based on QR code┐ consisting of:
(1) Q-POT Operator Server equipped with (11) Auto Info Process Unit including (12) Co-promotion Code Issue Apply Unit, (13) Subscription Accept Process Unit and (14) Operational Status Manage Unit;
(2) Individual Seller Server linked with (1) Q-POT Operator Server via (11) Auto Info Process Unit and applying the issuance of (4) Q-POT Code; and
(3) User Smart Terminal receiving advertisement information on (2) Individual Seller Server by scanning the (4) Q-POT Code attached to sales products and the qualification to enter for a lottery-typed online event

2. Whereas [claim 1],
(12) Co-promotion Code Issue Apply Unit is a lottery-typed product sales system for cash rewarding based on a QR code featuring a web program configuration consisting of (121) Code Issue Quantity Set Mode, (122) Saved Money Select Mode and (123) Seller Info Database.

3. Whereas [claim 1],
(13) Code Issue Control Unit is a lottery-typed product sales system for cash rewarding based on a QR code featuring a web program configuration consisting of (131) Q-POT Code Generate Mode, (132) Device Control Mode and (133) Q-POT Code Issuer operated and controlled by (132) Device Control Mode.

4. Whereas [claim 1],
(14) Subscription Accept Process Unit is a lottery-typed product sales system for cash rewarding based on a QR code featuring a web program configuration consisting of (141) Subscription Info Supply Mode, (142) Subscription Number Input Mode, (143) Set Advertisement Pop-up Mode and (144) Subscriber Info Database.

5. Whereas [claim 1],
(15) Operational Status Manage Unit is a lottery-typed product sales system for cash rewarding based on a QR code featuring a web program configuration consisting of (151) Cumulative Prize Money Output Mode, (152) Subscription Rate Analysis Mode, (153) Progress Data Pop-up Mode, (154) Lottery Manage Mode and (155) Winning Settlement Mode.

6. ┌Lottery-Typed Product Sales Service Method for Cash rewarding based on QR code┐ featuring the following seven (7) steps consisting of:
A step of (S1) Q-POT Code Apply is that (2) Individual Seller Server linked to (1) Q-POT Operator Server applies the issuance quantity of (4) Q-POT codes to attach to sales products via (121) Code Issue Quantity Set Mode installed in (12) Co-promotion Code Issue Apply Unit and selects a saved money per Q-POT code via (122) Saved Money Select Mode;
A step of (S2) Q-POT Code Generate is that (1) Q-POT Operator Server generates (4) Q-POT code via (131) Q-POT Code Generate Mode installed in (13) Code Issue Control Unit according to the information to apply the issuance of a Q-POT code supplied by (2) Individual Seller Server, inputs advertisement information and subscription limit code information to the (4) Q-POT Code generated and additionally attaches and generates (41) Subscription Identify Info and (42) Subscription Identify Mark thereto;
A step of (S3) Q-POT Code Print is that (1) Q-POT Operator Server sets and controls the (4) Q-POT Code generated in the step of (S2) Q-POT Code Generate via (132) Device Control Mode in order to attach to sales products of (2) Individual Seller Server and prints the (4) Q-POT Codes according to the quantity applied by (2) Individual Seller Server by operating (133) Q-POT Code Issuer;
A step of (S4) Subscription Accept is that (3) User Smart Terminal links to (1) Q-POT Operator Server by scanning (4) Q-POT Code attached to above sales products, offers information for how to subscribe, the period, the lottery date and so on to the (3) User Smart Terminal linked via (141) Subscription Info Supply Mode installed in (14) Subscription Accept Process Unit, saves the subscription information to (144) Subscriber Info Database by selecting and inputting the expected winning numbers via (142) Subscription Number Input Mode;
A step of (S5) Progress Notice is that (1) Q-POT Operator Server offers the current progress displayed in real time on (3) User Smart Terminal via (153) Progress Data Pop-up Mode by calculating a current subscription rate and the cumulative prize money for the event entered by (3) User Smart Terminal via (151) Cumulative Prize Money Output Mode and (152) Subscription Rate Analysis Mode installed in (15) Operational Status Manage Unit;
A step of (S6) Online Lottery is that (1) Q-POT Operator Server extracts a winning number in real time according to the set lottery date and time via (154) Lottery Manage Mode installed in (15) Operational Status Manage Unit and lets (3) User Smart Terminal confirm whether it wins or not by transmitting the winning number to (3) it; and
A step of (S7) Winning Info Notice is that (1) Q-POT Operator Server extracts the information for winning (3) User Smart Terminal from (144) Subscriber Info Database and transmits the whole winning information to the winning (3) User Smart Terminal by calculating the confirmative prize money, how to receive it, the payment period and tax amount to be deducted and the service charge to be deducted via (155) Winning Settlement Mode installed in (15) Operational Status Manager Unit.

7. Whereas [claim 6],
(1) Q-POT Operator Server is a lottery-typed product sales service method for cash rewarding based on a QR code offering (12-1) Saved Money Select Screen per Unit Price classified into colors, (12-2) Purchase Commission Info Screen per Q-POT code, (12-3) Code Issue Quantity Input Screen and (12-4) Product Info Screen on a web screen of (1) Q-POT Operator Server via (122) Saved Money Select Mode so that (2) Individual Seller Server sets and inputs a saved money desired per Q-POT code, a quantity of Q-POT code to purchase and the information of the sales product to attach (4) Q-POT Code.

8. Whereas [claim 6],
(4) Q-POT Code giving a qualification to enter for an event to (3) User Smart Terminal by scanning (4) it in a step of (S4) Subscription Accept is a lottery-typed product sales service method for cash rewarding based on a QR code featuring that the qualification is limited to one(1) time according to subscription limit code information recorded in the (4) Q-POT Code.

9. Whereas [claim 6],
(1) Q-POT Operator Server is a lottery-typed product sales service method for cash rewarding based on a QR code featuring that (3) User Smart Terminal, in the step of (S4) Subscription Accept, inputs and applies an expected winning numbers via (142) Subscription Number Input Mode and then another product information attaching (4) Q-POT Code is additionally exposed to (3) User Smart Terminal during the waiting time when such the expected winning numbers are transmitted and accepted.

10. Whereas [claim 6],
(4) Q-POT Code generated in the step of (S2) Q-POT Code Generate is a lottery-typed product sales service method for cash rewarding based on a QR code featuring that (4) it is attached to the sales product of (2) Individual Seller Server sold on an online shopping mall as an online transmission data and lets (3) User Smart Terminal enter for an event by scanning (4) it displayed on the (3) smart terminal when purchasing the product.

11. Whereas [claim 6],
The payment of the prize money drawn by the event lottery is a lottery-typed product sales service method for cash rewarding based on a QR code featuring that it is paid in a online cash point.
